(19) United States
(12) Patent Application Publication
(10) Pub. No.: US 2014/0079250 A1
(43) Pub. Date: Mar. 20, 2014

(54) INFORMATION DEVICE FOR MOVING OBJECT

(71) Applicant: Hideyuki Hirota, Tokyo (JP)

(72) Inventor: Hideyuki Hirota, Tokyo (JP)

(73) Assignee: Mitsubishi Electric Corporation, Tokyo (JP)

(21) Appl. No.: 14/115,841

(22) PCT Filed: Aug. 22, 2011
(86) PCT No.: PCT/JP2011/004653

§ 371 Date: Nov. 5, 2013

(51) Int. Cl. B60R 7/04; H04R 3/00

(52) U.S. Cl. CPC B60R 7/04; H04R 3/00
USPC 381/123; 224/539

(57) ABSTRACT

An information device for a moving object includes a display panel that is openable and closable via a rotating shaft of hinges, storing holes passing through the display panel, and a holding mechanism provided in the storing holes and holding stored devices fitted and stored in the storing holes.

### TECHNICAL FIELD

The present invention relates to an information device for a moving object equipped with a display to be mounted on a moving object such as a vehicle.

### BACKGROUND ART

For example, in Patent Document 1, there is disclosed a remote control for an electronic device including main buttons for making an input operation, a display for displaying the contents of the operation, and a recess in which a sub-remote control collecting major operation buttons of an electronic device is fittedly attached thereto. When a separate sub-remote control is attached to the recess, the remote control can be integrally carried with the corresponding sub-remote control.

### PRIOR ART DOCUMENTS

### Patent Documents

Patent Document 1: Japanese Patent Application Laid-open No. H9-130879

### SUMMARY OF THE INVENTION

### Problems to be Solved by the Invention

In an information device for a moving object such as an onboard display to be attached to a ceiling surface of a vehicle interior, generally, a mechanism for storing a remote control for making an input operation and/or a head phone for listening to sounds is not provided therein; thus, there are some cases where the remote control or headphone cannot be found at the moment to be used by a user, which poses a problem such that a search thereof through the vehicle interior is necessitated. In addition, when the remote control or the headphone is provided as a different body from the information device, they have to be carried separately, or carried with packed in one unit, resulting in a troublesome carrying work.

In the meantime, when a mechanism for attaching the remote control thereto is provided as disclosed in Patent Document 1, they can be integrally carried. However, in the conventional technique represented by Patent Document 1, the operation surface of the sub-remote control is always mounted thereto to face a predetermined surface of the main remote control. Namely, an aspect in which the sub-remote control and so on are mounted thereto is always fixed. Therefore, the operation of the sub-remote control is uniform, which poses a problem of poor convenience.

The present invention is made to solve the problems as described above, and an object of the invention is to provide an information device for a moving object capable of storing integrally the devices such as the remote control and the head phone, and improving convenience of the corresponding devices.

### Problems to be Solved by the Invention

An information device for a moving object according to the invention includes: a display panel openable and closable via a rotating shaft of a hinge; a device storing hole passing through the display panel; and a holding mechanism provided in the hole, and holding a device fitted and stored in the corresponding hole.

### Effects of the Invention

In accordance with the invention, there are an advantageous effect such that the devices such as remote control and head phone can be integrally stored therein, and that convenience of the corresponding devices can be improved.

### BRIEF DESCRIPTION OF THE DRAWINGS

FIG. 1 is a perspective view showing an onboard display device (display opened) according to Embodiment 1 of the present invention.

FIG. 2 is a perspective view showing the onboard display device (display closed) according to Embodiment 1.

FIG. 3 is a perspective view showing the onboard display device (display opened) with a remote control and a head phone stored therein.

FIG. 4 is a cross-sectional view showing a holding mechanism for the remote control and the head phone.

FIG. 5 is a perspective view showing an outer appearance of the remote control used in the onboard display device according to Embodiment 1.

FIG. 6 is a perspective view showing an outer appearance of the head phone used in the onboard display device according to Embodiment 1.

FIG. 7 is a perspective view showing the onboard display device (display closed) with the remote control and the head phone stored therein.

FIG. 8 is a perspective view showing another storage configuration of the remote control and the headphone in the onboard display device (display opened).

FIG. 9 is a perspective view showing the onboard display device (display opened) with a headphone having a remote control function stored therein.

FIG. 10 is a perspective view showing an onboard display device (display opened) according to Embodiment 2 of the invention.

FIG. 11 is a diagram showing a configuration of an output signal switching circuit.

FIG. 12 is a perspective view showing an onboard display device (display opened) according to Embodiment 3 of the invention.

FIG. 13 is a perspective view showing the onboard display device (display closed) according to Embodiment 3.

### BEST MODE FOR CARRYING OUT THE INVENTION

In the following, in order to explain the present invention in more detail, embodiments for carrying out the invention will be discussed with reference to the accompanying drawings.

### EMBODIMENT 1

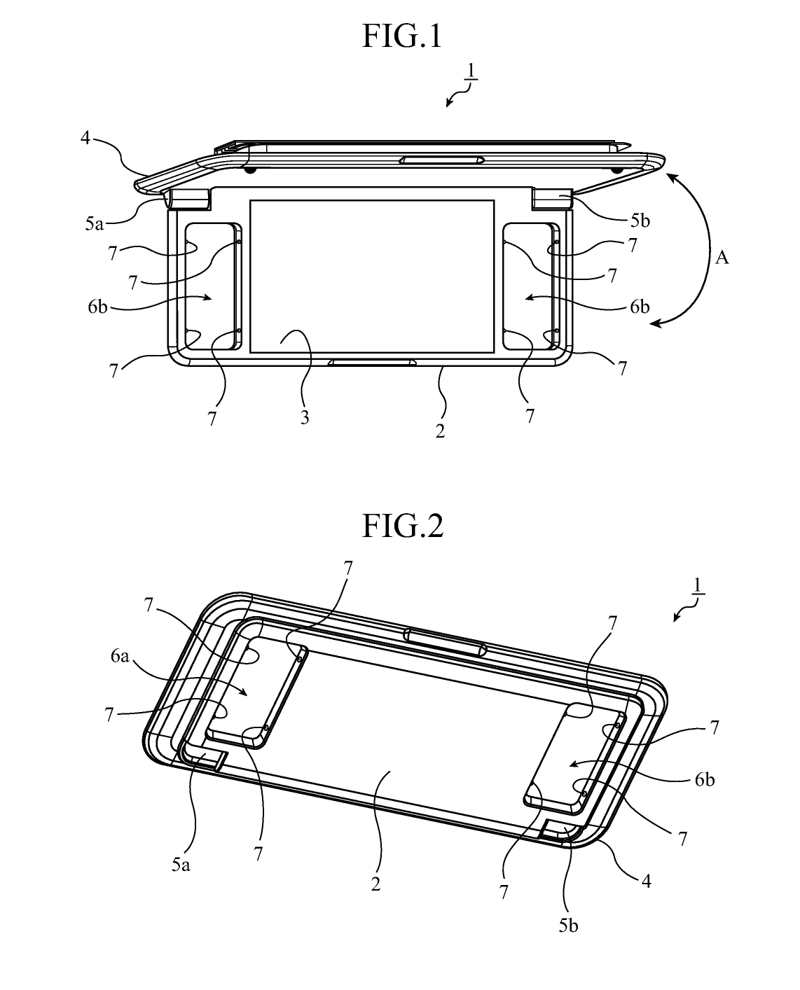

FIG. 1 is a perspective view showing an onboard display device (display opened) according to Embodiment 1 of the invention, and illustrates a case where a concept of an information device for a moving object according to the invention is applied to the onboard display device. On the other hand, FIG. 2 is a perspective view showing the onboard display device (display closed) according to Embodiment 1. In the onboard display device 1, a support housing 4 is attached to a ceiling surface of a vehicle interior, and a display panel 2 is supported to be openable/closable to the support housing 4 as shown in FIG. 1 and FIG. 2. More specifically, the display panel 2 is supported by a pair of hinges 5a and 5b provided on the left and right of the support housing 4 to thus open and close in the directions of an arrow A through a rotating shaft of the hinges 5a and 5b.

As shown in FIG. 1 and FIG. 2, storing holes 6a and 6b are formed on both sides of a display screen 3 of the display panel 2, and passes through the front and back of the display panel 2 (for example, when the display screen 3 is the front, and its opposite side is the back).

On the other hand, clampers 7 are provided in the inner walls of the storing holes 6a and 6b, and hold a stored device fitted in the storing holes 6a and 6b. Note that the stored device is the device to be used for an operation or an information output to the onboard display device 1, and specified by a remote control or a head phone, for example. Hereinafter, it will be described on the assumption that the storage devices correspond to the remote control and the head phone.

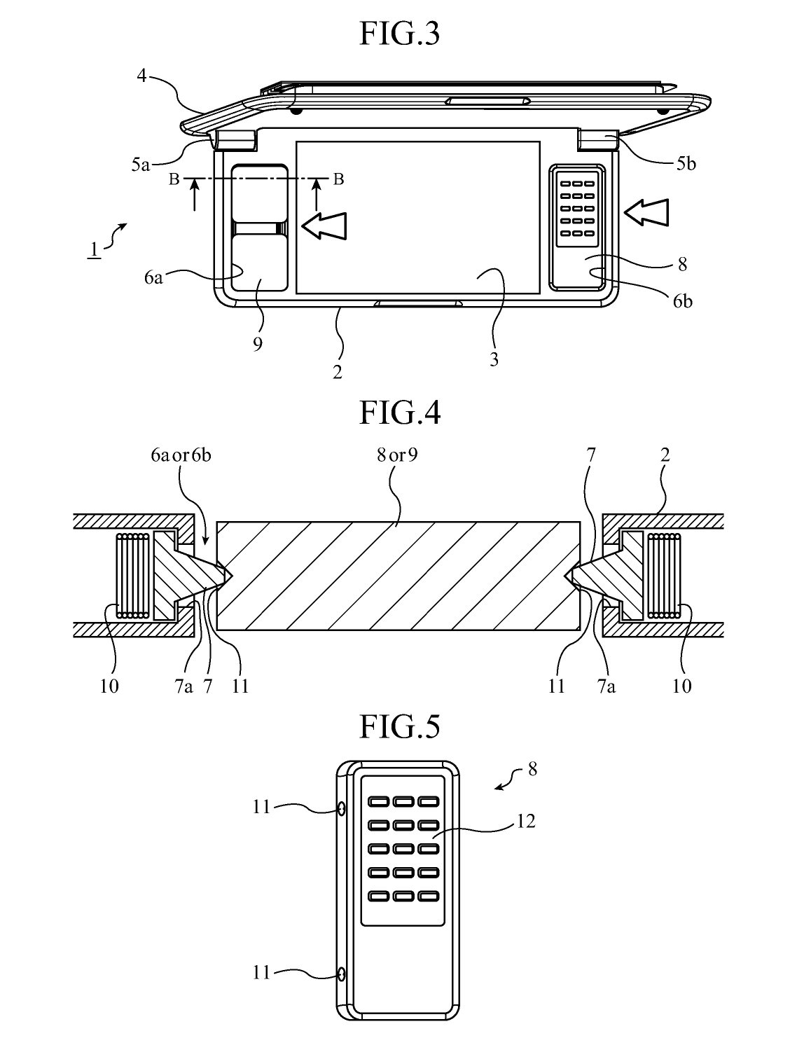

FIG. 3 is a perspective view showing the onboard display device (display opened) with the remote control and the head phone stored therein. As shown in FIG. 3, the remote control 8 that is the storage device is fitted in the storing hole 6b; when the remote control 8 that is the stored device is fitted in the storing hole 6b, the remote control 8 and the head phone 9 are stored in the display panel 2. Note that in an example of FIG. 3, the remote control 8 and the head phone 9 are fitted in the storing holes 6b and 6a from the directions of arrows in FIG. 3, respectively, to be thus stored such that the operation button side of the remote control 8 and the housing side of the head phone 9 face toward the display screen 3 side.

Next, a holding mechanism for the devices in the storing holes 6a and 6b will be described.

FIG. 4 is a cross-sectional view showing the holding mechanism for the remote control and the head phone, and schematically illustrates a cross section along a line B-B of FIG. 3. As shown in FIG. 4, holes 7a are formed in the inner walls of the storing holes 6a and 6b of the display panel 2 (at four locations for each storing hole in the example of FIG. 1 and FIG. 2), and the clampers 7 protrude from the inner walls of the storing holes 6a and 6b through the holes 7a. The clamper 7 has a tapered shape to be tip narrowed, and is urged in a protruding direction from the inner wall of the storing hole by a spring 10 provided inside the display panel 2. Moreover, recesses 11 are formed in the remote control 8 and the head phone 9 that are the stored devices. The recess 11 is a hole having a tapered shape to be bottom narrowed.

When the remote control 8 and the head phone 9 are pressed into the storing holes 6a and 6b, the clampers 7 first retract in the internal directions of the display panel 2 against the urging forces of the springs 10, and thereafter the tips thereof abut on the sides of the remote control 8 and the head phone 9. In this condition, the remote control 8 and the head phone 9 are further fit thereinto, the tips of the clampers 7 reach the recesses 11 prepared in the sides of the remote control 8 and the head phone 9, and then fit into the recesses 11. At this time, the tips of the clampers 7 are pressed against the inner walls of the recesses 11 by the urging forces of the springs 10.

In such a way, the remote control 8 and the head phone 9 are held with stored in the storing holes 6a and 6b. In FIG. 1 and FIG. 2, for example, the remote control 8 or the head phone 9 is held by the clampers 7 at four locations.

The stored devices will now be described.

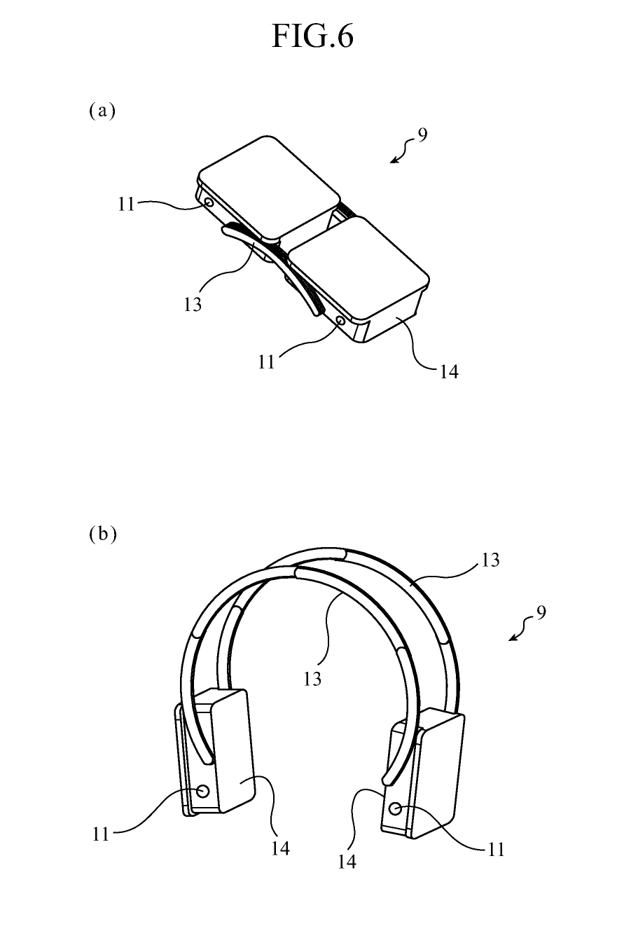

FIG. 5 is a perspective view showing an outer appearance of the remote control to be used in the onboard display device according to Embodiment 1. Also, FIG. 6 is a perspective view showing an outer appearance of the head phone to be used in the onboard display device according to Embodiment 1. As shown in FIG. 5 and FIG. 6, the recesses 11 for the holding by the clampers 7 are formed in the sides of the remote control 8 and the head phone 9.

Note that the onboard display device 1 of the remote control 8 can be operated when the buttons in the operation button part 12 are pressed.

The head phone 9 is stored in the storing hole 6a or 6b with a collapsible part 13 folded as shown in FIG. 6(a). Also, when the collapsible part 13 of the head phone 9 is extended as shown in FIG. 6(b), ear pads 14 are put in an opposed state. It is used by a user in this condition.

Next, a stored aspect of the stored device into the storing hole will be described.

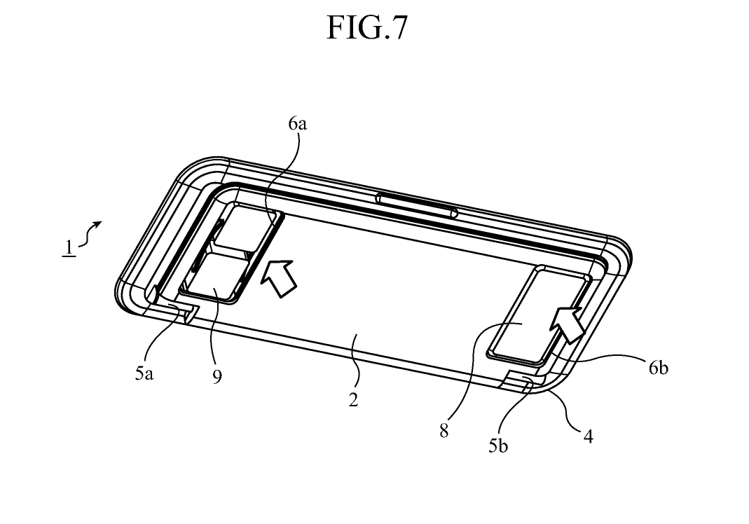

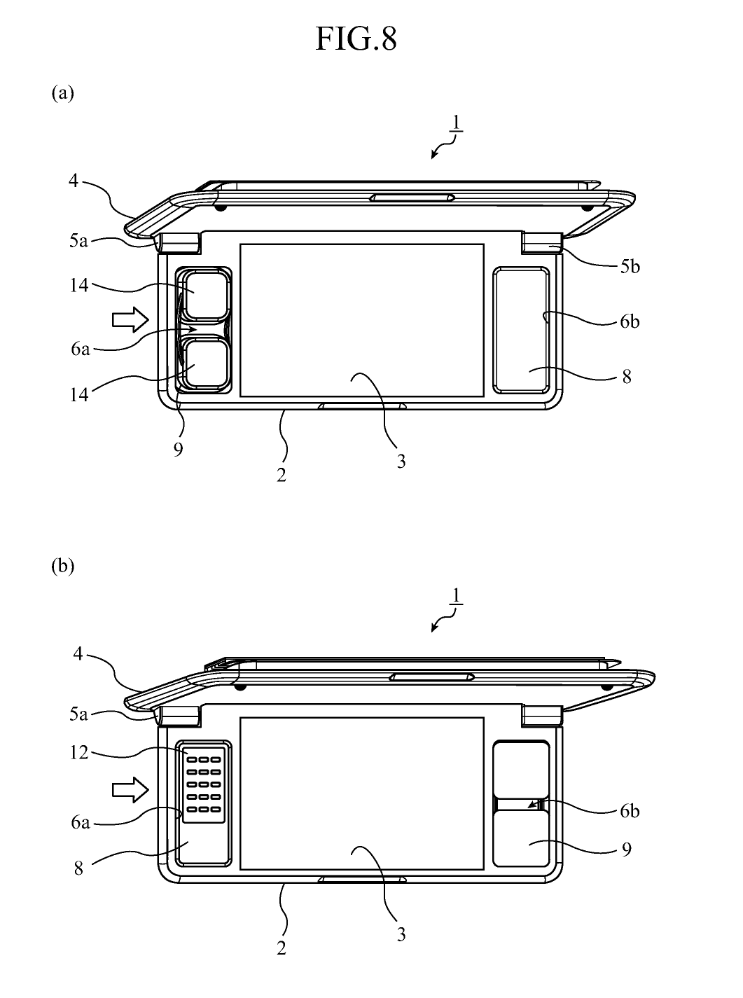

FIG. 7 is a perspective view showing the onboard display device (display closed) with the remote control and the head phone stored therein. FIG. 8 is a perspective view showing another stored configuration of the remote control and the head phone in the onboard display device (display opened).

Since the storing holes 6a and 6b are holes passing through the display panel 2, the remote control 8 and the head phone 9 can be fitted into the storing holes 6a and 6b in the directions of arrows in FIG. 7 to be stored therein with the display panel 2 closed on the support housing 4 side. In this way, even if the display panel 2 is put in a closed state, the remote control 8 and the head phone 9 can be stored therein, and an operation by the remote control 8 is also possible.

Additionally, though the remote control 8 may be stored with the operation button part 12 faced toward the display screen 3 side, the control maybe stored with its back side faced toward the display screen 3 side as shown in FIG. 8(a). At this time, the operation button part 12 can be operated from behind the display panel 2 (opposite side from the display screen 3). Thus, when the stored direction of the remote control 8 is only changed, for example, the operation from the driver seat side and the operation from the rear seat side can be switched, which can improve convenience of the remote control 8 that is the stored device.

Moreover, since the storing holes 6a and 6b are the holes passing through the front and back of the display panel 2, the holes are also usable as an operation grip for opening and closing the display panel 2 in a condition where no stored devices are stored therein.

Besides, though the head phone 9 may be stored with the housing side faced toward the display screen 3 side, the phone maybe stored with the ear pads 14 faced toward the display screen 3 side as shown in FIG. 8(a).

Further, since the storing holes 6a and 6b have the same holding mechanism, the remote control 8 and the head phone 9 can be stored with these right and left sides switched. Namely, when it is formed such that the interval between the clampers 7 in the storing holes 6a and 6b are the same as that between the recesses 11 in the remote control 8 and the headphone 9, it is also possible that the remote control 8 is stored in the storing hole 6a, while the head phone 9 is stored in the storing hole 6b, as shown in FIG. 8(b). When the remote control 8 or the headphone 9 can be similarly fitted in each of the storing holes 6a and 6b, these can be readily stored by the user.

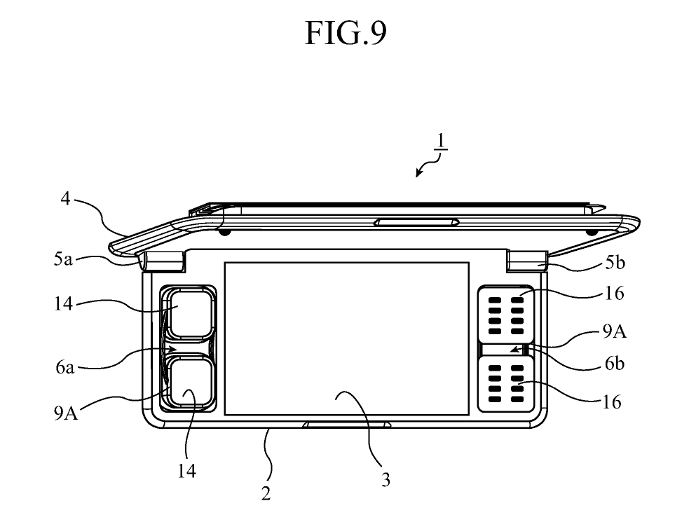

FIG. 9 is a perspective view of an onboard display device (display opened) with a headphone having a remote control function stored therein. A head phone 9A shown in FIG. 9 has an operation button part 16 on the housing side. This operation button part 16 enables the headphone 9A to function similarly to the remote control 8. In other words, the head phone 9A includes inside the housing a circuit for outputting sounds from the ear pads 14, and a circuit to be functioned as a remote control, and when the operation button part 16 is operated, a video display, a channel selection, and so on in the onboard display device 1 can be carried out.

As described above, the information device according to Embodiment 1 includes: a display panel 2 openable and closable via the rotating shaft of the hinges 5a and 5b; storing holes 6a and 6b passing through the display panel 2; and a holding mechanism provided in the storing holes 6a and 6b, and holding the stored devices fitted and stored in the storing holes 6a and 6b. This configuration enables the devices such as the remote control and the head phone to be integrally stored. In addition, the devices can be used even in a stored condition in the storing holes 6a and 6b, which enables to enhance convenience of the corresponding devices.

Moreover, according to Embodiment 1, the holding mechanism holds the devices stored in the storing holes 6a and 6b irrespective of whether a fitting direction of the devices into the holes 6a and 6b is from the display screen 3 side of the display panel 2 or from its back side. This configuration enables the devices to be operated from the display screen 3 side of the display panel 2 corresponding to the storing directions of the devices, and also enables the devices to be operated from its back (opposite) side contrarily. Thus, convenience of the devices can be improved.

### EMBODIMENT 2

In Embodiment 2, an onboard display device that uses a stored device as an external speaker will be described.

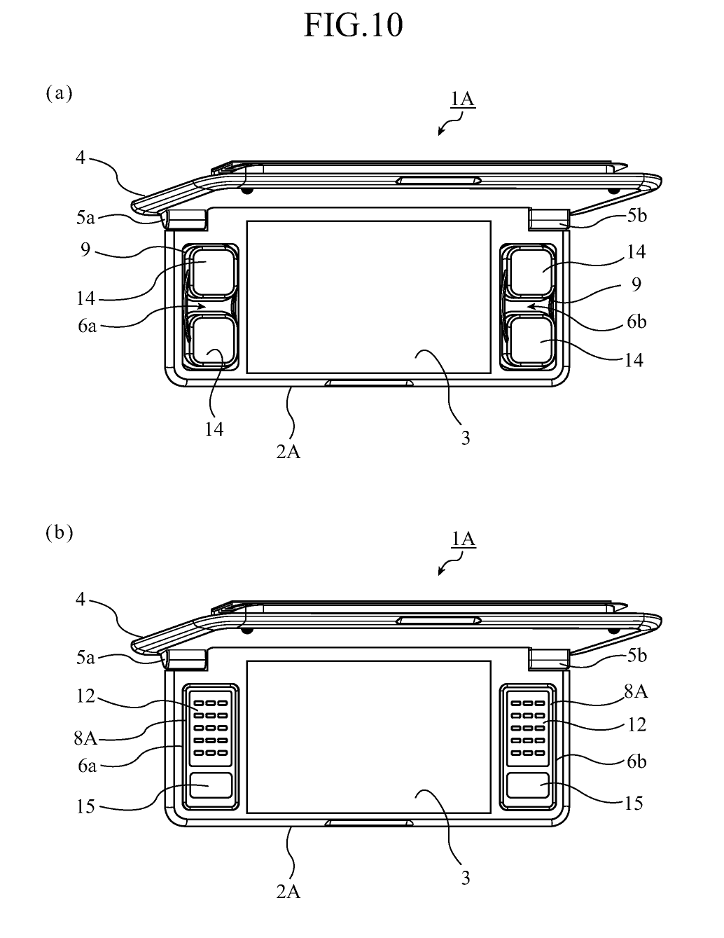

FIG. 10 is a perspective view showing an onboard display device (display opened) according to Embodiment 2 of the invention. An example in FIG. 10(a) shows an onboard display device 1A that uses head phones 9 as external speakers. In this instance, the two head phones 9 are stored, respectively, in the storing holes 6a and 6b of the display panel 2A such that ear pads 14 face toward the display screen 3 side. When the storage of the head phones 9 into the storing holes 6a and 6b is detected, the display panel 2A includes an output sound switching circuit for outputting a sound output signal for the external speaker to the head phones 9.

An example in FIG. 10(b) shows an onboard display device 1A that uses remote controls 8A with a speaker. The remote control 8A is the remote control having a built-in speaker 15. For example, it is used when the user wishes to listen to the sounds from the onboard display device 1A at hand.

In the onboard display device 1A, the two remote controls 8A are stored in the storing holes 6a and 6b of the display panel 2A such that the speakers 15 face toward the display screen 3 side, respectively. When the storage of the remote controls 8A into the storing holes 6a and 6b is detected, the output sound switching circuit of the display panel 2A outputs the sound output signal for the external speaker to the speakers 15 of the remote controls 8A.

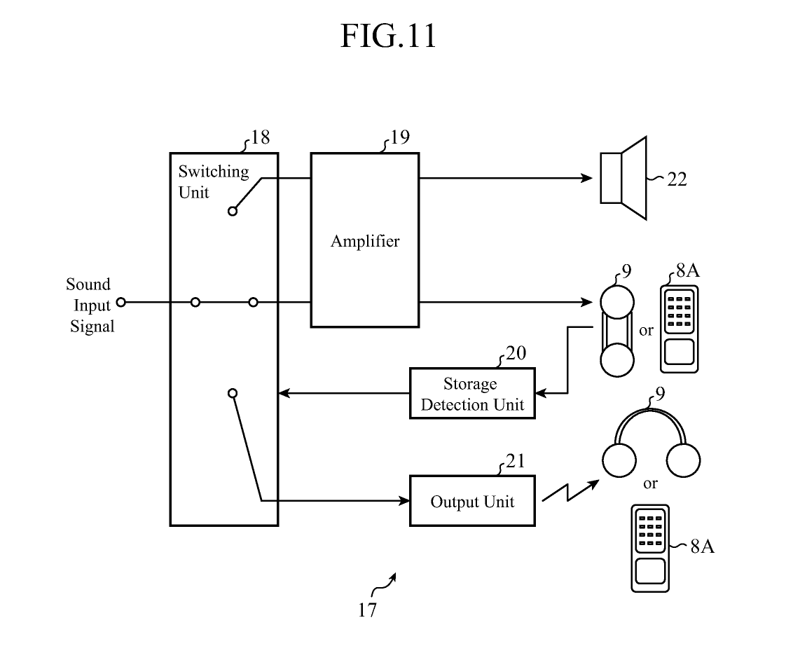

FIG. 11 is a diagram showing one example of a configuration of the aforementioned output signal switching circuit. As shown in FIG. 11, the output sound switching circuit 17 is the circuit that is arranged inside the display panel 2A or the support housing 4, and that switches an output destination of the sounds reproduced in the onboard display device 1A, and includes a switching unit 18, an amplifier 19, a storage detection unit 20, and an output unit 21.

The switching unit 18 is a component that changes an output destination of a sound input signal in accordance with a detection result from the storage detection unit 20. The amplifier 19 amplifies the sound output signal to be output to an external speaker 22 or to the remote control 8A and the head phone 9 stored in the storing holes 6a and 6b. The storage detection unit 20 is the detection unit that detects the storage of a stored device into the storing hole 6a or 6b of the display panel 2A. For example, when the stored device is stored in the storing hole 6a or 6b, the detection unit detects a connection between a sound signal output terminal from the amplifier 19 and a sound signal input terminal of the stored device. The output unit 21 outputs the sounds to the remote control 8A and the head phone 9 in a normal use, which is not in a condition stored in the storing holes 6a and 6b. The sound signal is transmitted through a short range wireless communication system such as Bluetooth (registered trademark).

The external speaker 22 is the speaker prepared separately from the onboard display device 1A; for example, it is an onboard speaker installed in a vehicle interior.

Next, an operation thereof will be described.

(1) Case of Normal Sound Output

When the onboard display device 1A is set in an operation mode for outputting the sounds by the external speaker 22, the switching unit 18 switches the output destination of the sound input signal to a path to the external speaker 22. Thus, the sound signal amplified by the amplifier 19 is audio output from the external speaker 22.

In contrast, when the onboard display device 1A is set in an operation mode for outputting the sounds by the remote control 8A or the headphone 9 in a condition that is not stored in the display panel 2A, the switching unit 18 switches the output destination of the input sound signal to a path to the output unit 21. The output unit 21 adjusts the input sound signal to an output level suitable for the speaker 15 of the remote control 8A or the head phone 9, and outputs the resultant to the remote control 8A or the headphone 9. In this manner, the sound signal is audio output by the speaker 15 of the remote control 8A or the head phone 9.

(2) Case of Sound Output in Stored Device

When the headphones 9 are respectively stored in the storing holes 6a and 6b as shown in FIG. 10(a), or when the remote controls 8A are respectively stored in the storing holes 6a and 6b as shown in FIG. 10(b), the storage detection unit 20 detects the storage of the remote controls 8A or the head phones 9, and sends the detection information to the switching unit 18. When the switching unit 18 receives detection information indicative of the storage of the remote controls 8A or the head phones 9, the unit changes the output destination of the sound input signal to a path to the stored remote controls 8A or head phones 9. In this manner, the sound signal amplified by the amplifier 19 is output by the speakers 15 of the remote controls 8A or the head phones 9.

As described above, the information device according to Embodiment 2 includes: the storage detection unit 20 for detecting storage of a device having a sound output unit such as the speaker 15 into the storing holes 6a and 6b; and the switching unit 18 for switching the output destination of the sound signal to the sound output unit of the corresponding stored device when the storage detection unit 20 detects the storage of the device. The remote control 8A and the head phone 9 can be integrally stored by the storing holes 6a and 6b formed in the display panel 2A, similarly to the above Embodiment 1. Moreover, the audio output is possible with the speaker 15 of the remote control 8A or the head phone 9 stored therein, and hence convenience of the remote control 8A and the head phone 9 can be further improved.

### EMBODIMENT 3

In the above Embodiments 1 and 2, there are shown the configurations in which the display panel is opened and closed via the shaft of the pair of hinges on the left and right provided in the support housing; however, in Embodiment 3, there is shown a configuration in which the display panel is opened and closed, and rotated when the display panel is supported with a biaxial hinge.

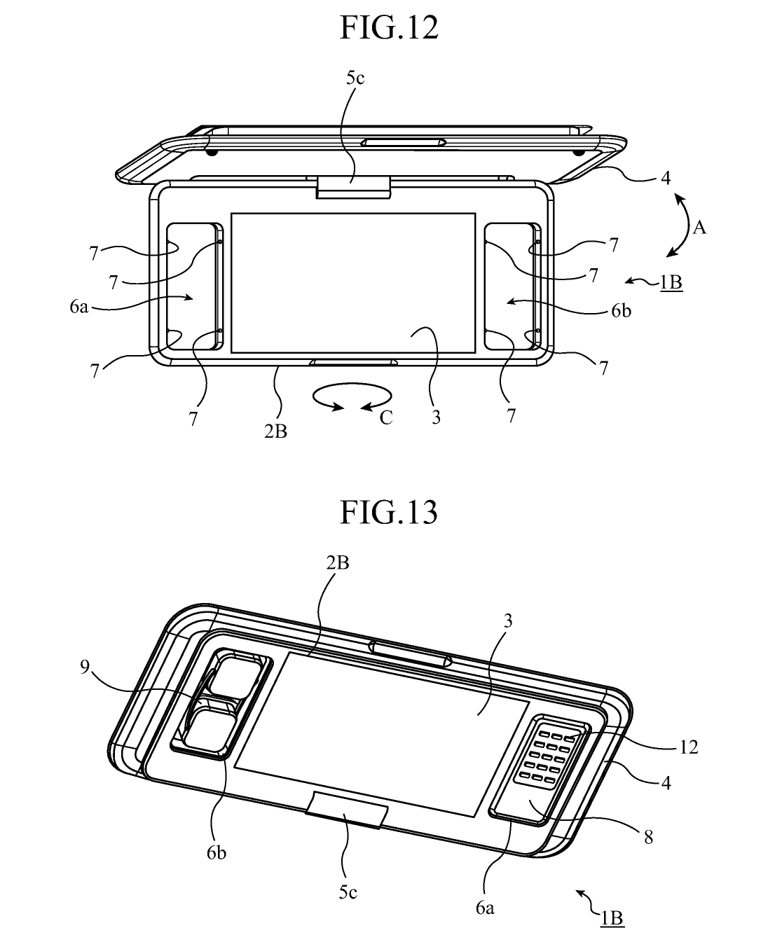

FIG. 12 is a perspective view showing an onboard display device (display opened) according to Embodiment 3 of the invention. In an onboard display device 1B according to Embodiment 3, as shown in FIG. 12, a display panel 2B is attached to a support housing 4 via a biaxial hinge 5c. The biaxial hinge 5c has two orthogonal rotating shafts. The display panel 2B can be opened and closed in the directions of an arrow A via a rotating shaft in a left-right direction of the biaxial hinge 5c, and is rotatable in the directions of an arrow C via a rotating shaft orthogonal to the above.

In the display panel 2B, storing holes 6a and 6b passing through the front and back of the display panel 2B are formed on both sides of the display screen 3 similarly to Embodiments 1 and 2 described above. Accordingly, when the storing holes 6a and 6b can be used as an operation grip, the opening and closing, and rotation of the display panel 2B can be easily carried out.

In addition, in a case where a holding mechanism similar to that of Embodiment 1 is provided in the storing holes 6a and 6b, a stored device can be readily stored therein by a user when the device is similarly fit into each of the storing holes 6a and 6b. For example, different stored devices maybe stored with these left and right sides replaced, and may be stored from the front side of the display panel 2B, or stored from the back side thereof.

FIG. 13 is a perspective view showing the onboard display device (display closed) according to Embodiment 3. An example in FIG. 13 shows a case in which the display panel 2B is rotated via the biaxial hinge 5c, and closed with the front and back reversed. In this way, even if the display panel 2B is closed, a remote control 8 and a head phone 9 can be stored therein, and an operation by the remote control 8 is also possible. The onboard display device 1B is a display attached to a ceiling surface of a vehicle interior; thus, when a condition as shown in FIG. 13 is achieved, for example, a viewing becomes possible in a condition such that a seat is reclined and laid.

As described above, according to Embodiment 3, the display panel 2B is openable and closable, and rotatable via the biaxial hinge 5c with the orthogonal rotating shafts. Even in the display panel 2B, the remote control 8A and the headphone 9 can be integrally stored by the storing holes 6a and 6b similarly to the above Embodiment 1. Since a use in a rotated condition of the display panel 2B is also possible, convenience of the remote control 8 and the head phone 9 can be further improved.

In the above Embodiments 1 to 3, there are shown the cases in which the concept of the information device for a moving object of the present invention is applied to the onboard display device, it is not limited to the above examples. It may be applied to, for example, an entertainment system in a passenger room of a railway, a ship, an airplane, or the like.

It is noted that in the present invention, it is possible to freely combine the embodiments, modify any component of the embodiments, or omit any component in the embodiments within the scope of the invention.

### INDUSTRIAL APPLICABILITY

The information device for a moving object according to the present invention can store integrally the device such as the remote control and the head phone, and improve convenience of the device, and hence it is suitable for an onboard display device.

1, 1A, 1B: onboard display device

2, 2A, 2B: display panel

3: display screen

4: support housing

5a, 5b: hinge

5c: biaxial hinge

6a, 6b: storing hole

7: clamper

8, 8A: remote control

9, 9A: head phone

10: spring

11: recess

12, 16: operation button side

13: collapsible part

14: ear pad

15, 22: speaker

17: output signal switching circuit

18: switching unit

19: amplifier

20: storage detection unit

21: output unit.

1. An information device for a moving object, comprising:
a display panel openable and closable via a rotating shaft of a hinge;
a device storing hole passing through the display panel; and
a holding mechanism that is provided in the hole, and that holds a device fitted and stored in the hole.

2. The information device for a moving object according to claim 1, wherein the holding mechanism holds the device stored in the hole irrespective of whether a fitting direction of the device into the hole is from a display screen side of the display panel or from a back side thereof.

3. The information device for a moving object according to claim 1, wherein the display panel is openable and closable, and rotatable via a hinge with orthogonal rotating shafts.

4. The information device for a moving object according to claim 1, further comprising a storage detection unit for detecting storage of a device having a sound output unit into the hole; and
a switch unit that switches an output destination of a sound signal to the sound output unit of the stored device when the storage detection unit detects the storage of the stored device.
